(19) United States
(12) Patent Application Publication
(10) Pub. No.: US 2025/0239401 A1
(43) Pub. Date: Jul. 24, 2025

(54) MULTILAYER CERAMIC ELECTRONIC COMPONENT AND MANUFACTURING METHOD OF MULTILAYER CERAMIC ELECTRONIC COMPONENT

(71) Applicant: TAIYO YUDEN CO., LTD., Tokyo (JP)

(72) Inventor: Riki SUEMASA, Takasaki-shi (JP)

(21) Appl. No.: 18/986,214

(22) Filed: Dec. 18, 2024

(30) Foreign Application Priority Data
Dec. 25, 2023 (JP) 2023-218263

(51) Int. Cl. H01G 4/12; H01G 4/008; H01G 4/33

(52) U.S. Cl. CPC H01G 4/1227; H01G 4/008; H01G 4/33

(57) ABSTRACT

A multilayer ceramic electronic component including a plurality of internal electrode layers, a plurality of dielectric layers having a perovskite structure represented by a general formula ABO₃, wherein the internal electrode layers and the dielectric layers are alternately laminated along a first axis, wherein an intermediate layer is provided between an internal electrode layer and a dielectric layer, which are adjacent each other, along the first axis. When a main component element of the internal electrode layer is M, an element at an A-site of the dielectric layer is A, and an element at a B-site is B, the intermediate layer includes M atoms, B atoms, and oxygen atoms, wherein a combined proportion of M atoms, B atoms, and oxygen atoms in the intermediate layer is 50 at % or more, and a proportion of A atoms is 5 at % or less.

### BACKGROUND OF THE INVENTION

### Field of the Invention

The disclosure herein relates to multilayer ceramic electronic components and manufacturing methods of multilayer ceramic electronic components.

### Description of the Related Art

Multilayer ceramic electronic components such as multilayer ceramic capacitors (MLCCs) have been developed for use in various electronic devices such as smartphones and personal computers.

In order to miniaturize a multilayer ceramic electronic component and increase its capacitance, dielectric layers are thinned. However, if the dielectric layers are thinned, electric field strength applied per dielectric layer becomes relatively high, and there is a risk of lowering insulation between electrodes.

It is an object of the present disclosure to provide a multilayer ceramic electronic component and a manufacturing method of a multilayer ceramic electronic component which can obtain high insulation between electrodes.

### BACKGROUND ART LITERATURES

### Patent Literature

[Patent Literature 1] Japanese Unexamined Patent Publication No. 2014-103422
[Patent Literature 2] Japanese Unexamined Patent Publication No. 2022-181544

### Non-Patent Literature

[Non-patent Literature 1] Chemical Physics Letters, 2017, 685: 23-26

### SUMMARY OF THE INVENTION

According to an embodiment of the present disclosure, a multilayer ceramic electronic component includes a plurality of internal electrode layers laminated along a first axis, a plurality of dielectric layers having a perovskite structure represented by a general formula ABO₃, and positioned between adjacent internal electrode layers of the plurality of internal electrode layers, an intermediate layer positioned between an internal electrode layer of the plurality of internal electrode layers and a dielectric layer of the plurality of dielectric layers which are adjacent each other, wherein when a main component element of the internal electrode layer is referred to as M, an element at an A-site of the dielectric layer is referred to as A, and an element at a B-site is referred to as B, the intermediate layer includes M atoms, B atoms, and oxygen atoms, wherein a combined proportion of M atoms, B atoms, and oxygen atoms in the intermediate layer is 50 at % or more, and a proportion of A atoms is 5 at % or less.

According to the present disclosure, it is possible to obtain high insulation between electrodes.

### BRIEF DESCRIPTION OF THE DRAWINGS

FIG. 1 is a partially cross-sectional perspective view illustrating a multilayer ceramic capacitor according to a first embodiment;

FIG. 2 is a cross-sectional view (part 1) illustrating the multilayer ceramic capacitor according to the first embodiment;

FIG. 3 is a cross-sectional view (part 2) illustrating the multilayer ceramic capacitor according to the first embodiment;

FIG. 4 is a cross-sectional view illustrating details of an element body according to the first embodiment;

FIG. 5 is a drawing illustrating a band alignment of an internal electrode layer, an intermediate layer, and a dielectric layer according to the first embodiment;

FIG. 6 is a flowchart illustrating a manufacturing method of the multilayer ceramic capacitor;

FIG. 7A is a drawing (part 1) illustrating a manufacturing method of a lamination unit of the multilayer ceramic capacitor;

FIG. 7B is a drawing (part 1) illustrating a laminating method of lamination units of the multilayer ceramic capacitor;

FIG. 8 is a drawing (part 2) illustrating a manufacturing method of the multilayer ceramic capacitor;

FIG. 9 is a drawing illustrating an application of a side margin part;

FIG. 10 is a cross-sectional view illustrating details of an element body according to a variation of the first embodiment;

FIG. 11 is a drawing illustrating a band alignment of an internal electrode layer, a first region, a second region, and a dielectric layer according to the variation of the first embodiment;

FIG. 12 is a cross-sectional view illustrating details of an element body according to a second embodiment;

FIG. 13 is a cross-sectional view illustrating details of an element body according to the variation of the second embodiment;

FIG. 14 is a cross-sectional view illustrating details of an element body according to a third embodiment;

FIG. 15 is a drawing illustrating concentration distributions of barium, titanium, oxygen, nickel and gold according to the third embodiment;

FIG. 16 is a cross-sectional view illustrating details of an element body according to the variation of the third embodiment;

FIG. 17 is a cross-sectional view illustrating details of an element body according to a fourth embodiment;

FIG. 18 is a cross-sectional view illustrating details of an element body according to a variation of the fourth embodiment; and

FIG. 19 is a drawing illustrating concentration distributions of barium, titanium, oxygen, nickel, tin and gold in a variation according to the fourth embodiment.

### DETAILED DESCRIPTION OF EMBODIMENTS

In the following, embodiments of the present invention will be described in detail, but the present disclosure is not limited thereto. It should be noted that in the present specification and the drawings, components having substantially the same functional configuration may be given the same reference numerals, thereby omitting redundant description. Also, in the drawings, an X-axis, a Y-axis, and a Z-axis, which are mutually orthogonal, are shown as appropriate. The X-axis, the Y-axis, and the Z-axis define a fixed coordinate system fixed with respect to a multilayer ceramic capacitor.

### First Embodiment

First, a first embodiment will be described. The first embodiment relates to the multilayer ceramic capacitor.

### [Structure of Multilayer Ceramic Capacitor]

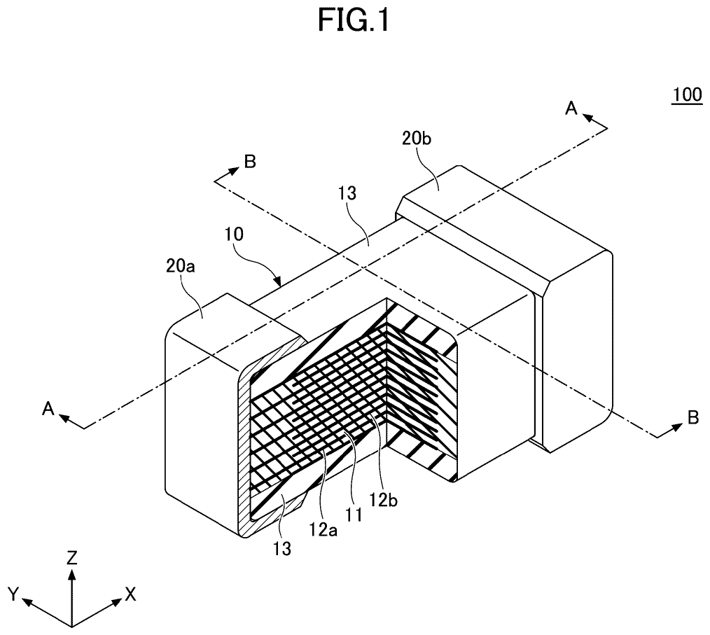

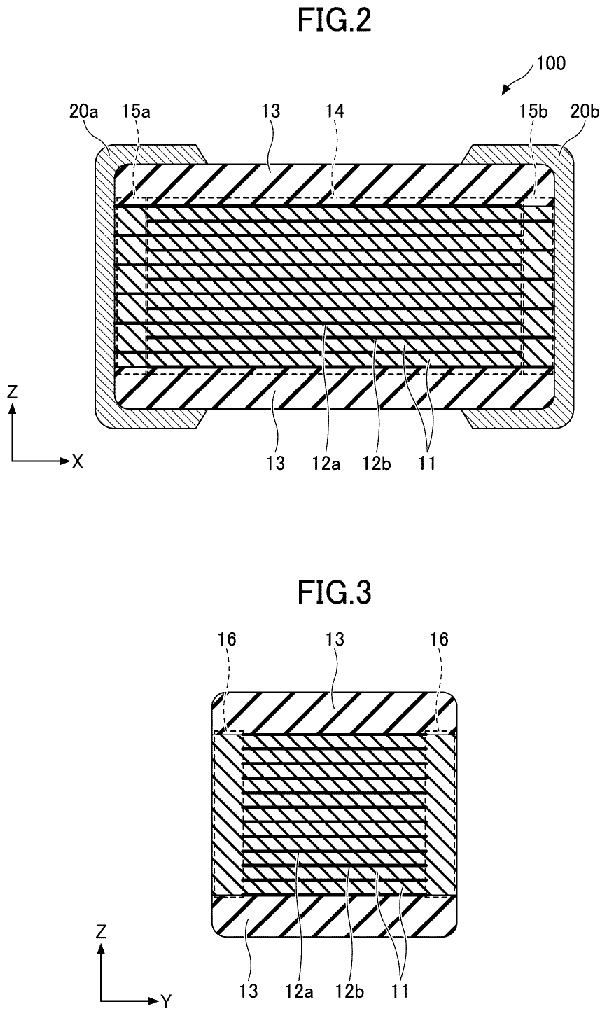

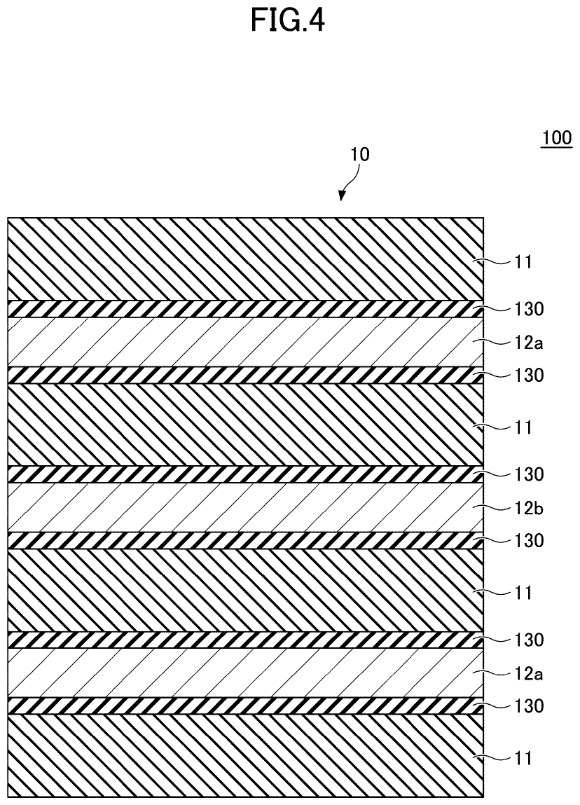

FIG. 1 is a partial cross-sectional perspective view illustrating the multilayer ceramic capacitor 100 according to the first embodiment. FIGS. 2 and 3 are cross-sectional views illustrating the multilayer ceramic capacitor according to the first embodiment. FIG. 2 is a cross-sectional view taken along line A-A in FIG. 1. FIG. 3 is a cross-sectional view taken along line B-B in FIG. 1. As shown in FIGS. 1 to 3, the multilayer ceramic capacitor 100 includes an element body 10 having a roughly rectangular parallelepiped shape. In the element body 10, two surfaces facing each other are referred to as an upper face and a lower face, and four surfaces connecting the upper face and the lower face are referred to as lateral faces. Generally, a surface facing a substrate when the multilayer ceramic capacitor is mounted on a circuit board is referred to as a lower face, but this is not required. In an example of FIGS. 1 to 3, a first external electrode 20a and a second external electrode 20b are provided on two lateral faces (first lateral face and second lateral face) facing each other in the element body 10. The first external electrode 20a extends from the first lateral face to four adjacent surfaces. The second external electrode 20b extends from the second lateral face to four adjacent surfaces. However, the first external electrode 20a and the second external electrode 20b are spaced apart from each other. The external electrodes may be provided not only on the two opposing lateral faces as long as they are on the surface of the element body 10.

In the present embodiment, as an example, the first external electrode 20a is used as an anode and the second external electrode 20b is used as a cathode. It is preferable to provide an external distinction such as a marker so that the first external electrode 20a and the second external electrode 20b can be distinguished.

It should be noted that in FIGS. 1 to 3, a first direction, which is a lamination direction, is a Z-axis direction, and a direction in which the internal electrode layers face each other. A second direction, which is a direction perpendicular to the lamination direction, is an X-axis direction, which is a longitudinal direction of the element body 10, and a direction in which the first lateral face and the second lateral face of the element body 10 face each other, and a direction in which the first external electrode 20a and the second external electrode 20b face each other. A third direction, which is perpendicular to the lamination direction and perpendicular to the second direction, is a Y-axis direction, which is a width direction of the internal electrode layer, and a direction in which two lateral faces (the third lateral face and the fourth lateral face) other than the first lateral face and the second lateral face among the four lateral faces of the element body 10 face each other. The X-axis direction, the Y-axis direction, and the Z-axis direction are orthogonal to each other.

The element body 10 has a configuration with alternately laminated of a dielectric layer 11 containing a ceramic material functioning as a dielectric material, and the internal electrode layer. The internal electrode layer includes a plurality of first internal electrode layers 12a and a plurality of second internal electrode layers 12b. The first internal electrode layer 12a and the second internal electrode layer 12b are alternately laminated. An edge of the first internal electrode layer 12a is extracted to the surface of the element body 10 on which the first external electrode 20a is provided, or the first lateral face in the example of FIGS. 1 to 3. An edge of the second internal electrode layer 12b is extracted to the surface of the element body 10 on which the second external electrode 20b is provided, or the second lateral face in the example of FIGS. 1 to 3. Thus, the first internal electrode layer 12a and the second internal electrode layer 12b alternately conduct to the first external electrode 20a and the second external electrode 20b. As a result, the multilayer ceramic capacitor 100 has a configuration in which capacitor units are laminated. Also, in a laminated body of the dielectric layers 11 and the internal electrode layers, the internal electrode layers are arranged on outermost layers in a laminating direction, and outer surfaces in the laminating direction of the laminated body, the upper face and the lower face in the example of FIGS. 1 to 3, are covered with cover layers 13. The cover layers 13 are mainly composed of the ceramic material. For example, the cover layer 13 may have a composition that is the same as or different from that of the dielectric layer 11. The structure shown in FIGS. 1 to 3 is not limited as long as the first internal electrode layer 12a and the second internal electrode layer 12b are exposed in different regions on the surface of the laminated body and are conductive to different external electrodes. The different regions on the surface of the laminated body may be respective surface regions on opposing surfaces of the laminated body, may be respective surface regions on adjacent surfaces of the laminated body, or may be respective different surface regions on the same surface of the laminated body. As long as the different external electrodes are separated from each other, the first internal electrode layer 12a and the second internal electrode layer 12b may extend from the surface exposed in the surface region of the laminated body to the other surface.

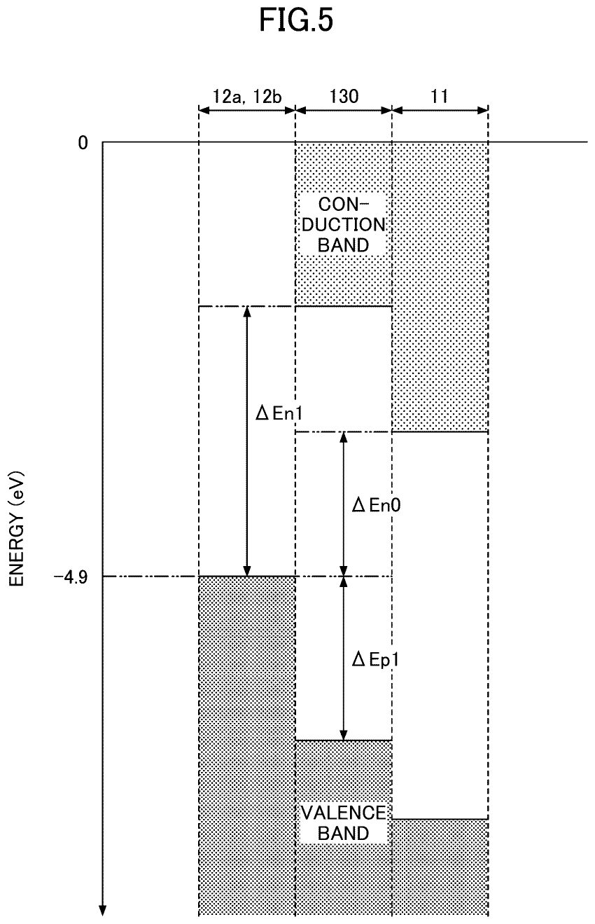

As will be described in detail below, the element body 10 further includes a plurality of intermediate layers 130 (see FIG. 4). In FIGS. 1 to 3, the intermediate layers 130 are omitted.

A size of the multilayer ceramic capacitor 100 is: for example, 0.25 mm long, 0.125 mm wide, and 0.125 mm high; 0.4 mm long, 0.2 mm wide, and 0.2 mm high; 0.6 mm long, 0.3 mm wide, and 0.3 mm high; 1.0 mm long, 0.5 mm wide, and 0.5 mm high; 3.2 mm long, 1.6 mm wide, and 1.6 mm high; or 4.5 mm long, 3.2 mm wide, 2.5 mm high, but is not limited to these examples. A size of the multilayer ceramic capacitor 100 may be, for example, length>width≥height, width>length≥height, height>length≥width, or height>width≥length.

The dielectric layer 11 has, for example, a ceramic material having a perovskite structure represented by the general formula ABO₃ as a main phase. The perovskite structure contains ABO_{3-α} which is not stoichiometric (0≤α≤1:α represents a quantity that deviates from the stoichiometric composition; hereinafter a is omitted). For example, the ceramic material may be selected from at least one of barium titanate (BaTiO₃), calcium zirconate (CaZrO₃), calcium titanate (CaTiO₃), strontium titanate (SrTiO₃), magnesium titanate (MgTiO₃), Ba_{1-x-y}CaₓSr_{y}Ti_{1-z}Zr_{z}O₃ (0≤x≤1, 0≤y≤1, 0≤z≤1) forming a perovskite structure, and the like. Ba_{1-x-y}CaₓSr_{y}Ti_{1-z}Zr_{z}O₃ includes barium strontium titanate, barium calcium titanate, barium zirconate, barium zirconate titanate, calcium zirconate titanate, barium calcium zirconate titanate, etc. For example, the dielectric layer 11 contains 50 at % or more, e.g., 90 at % or more of the main component ceramic.

An additive may be added to the dielectric layer 11. Additives to the dielectric layer 11 include oxides of zirconium (Zr), magnesium (Mg), manganese (Mn), molybdenum (Mo), vanadium (V), chromium (Cr), rare earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb)), oxides containing cobalt (Co), nickel (Ni), lithium (Li), boron (B), sodium (Na), potassium (K), or silicon (Si), or glass containing cobalt, nickel, lithium, boron, sodium, potassium, or silicon.

As shown in FIG. 2, the region where the first internal electrode layer 12a connected to the first external electrode 20a and the second internal electrode layer 12b connected to the second external electrode 20b face each other is a region where an electric capacitance is generated in the multilayer ceramic capacitor 100. Accordingly, the region where the electric capacitance is generated is referred to as a capacitive part 14. That is, the capacitive part 14 is a region where adjacent internal electrode layers connected to different external electrodes face each other.

A region where the first internal electrode layers 12a connected to the first external electrode 20a face each other in the lamination direction without having the second internal electrode layer 12b connected to the second external electrode 20b interposed therebetween is referred to as a first end margin 15a. Also, a region where the second internal electrode layers 12b connected to the second external electrode 20b face each other in the lamination direction without having the first internal electrode layer 12a connected to the first external electrode 20a interposed therebetween is referred to as a second end margin 15b. Each end margin is a region where the internal electrode layers connected to the same external electrode face each other in the lamination direction without having the internal electrode layers connected to different external electrodes interposed therebetween. The first end margin 15a and the second end margin 15b are regions that do not generate electric capacitance.

A side margin 16 is a region provided outside the capacitive part 14 in the Y-axis direction in the example of FIG. 3 in the third direction perpendicular to the lamination direction and perpendicular to the second direction. That is, the side margin 16 is an outer region adjacent to the capacitive part 14 when viewed from the lamination direction and an outer region adjacent to the capacitive part 14 on the side where the internal electrode layer is not extracted. The side margin 16 is also a region that does not generate electric capacitance.

The first internal electrode layer 12a and the second internal electrode layer 12b are mainly composed of base metals such as nickel (Ni), copper (Cu), and tin (Sn) or alloys containing these metals. A noble metal such as platinum (Pt), palladium (Pd), silver (Ag), gold (Au), or an alloy containing these metals may be used as the main components of the first internal electrode layer 12a and the second internal electrode layer 12b. The main components of the first internal electrode layer 12a and the main components of the second internal electrode layer 12b may be the same or different. As an example, the main components of the first internal electrode layer 12a and the second internal electrode layer 12b may both be nickel, or they may both be copper.

The configuration of the element body 10 will now be described in detail. FIG. 4 is a cross-sectional view illustrating details of the element body 10 according to the first embodiment.

In the multilayer ceramic capacitor 100 according to the first embodiment, the element body 10 has the intermediate layer 130 between the dielectric layer 11 and the first internal electrode layer 12a, and between the dielectric layer 11 and the second internal electrode layer 12b. When the element of the main component of the first internal electrode layer 12a and the second internal electrode layer 12b is referred to as M, the element at the A-site of the perovskite structure of the dielectric layer 11 is referred to as A, and the element at the B-site is referred to as B, the intermediate layer 130 positioned between the adjacent first internal electrode layer 12a and the dielectric layer 11 contains M atoms, B atoms, and oxygen atoms, and substantially does not contain the element A. Similarly, the intermediate layer 130 positioned between the adjacent second internal electrode layer 12b and the dielectric layer 11 also contains M atoms, B atoms, and oxygen atoms, and substantially does not contain the element A. Also, in the intermediate layer 130, the proportion of M atoms, B atoms, and oxygen atoms is 50 at % or more in total, and the proportion of A atoms is 5 at % or less. For example, the M atom is nickel, the A atom is barium, and the B atom is titanium.

FIG. 5 shows the band alignments of the first internal electrode layer 12a, the second internal electrode layer 12b, the intermediate layer 130, and the dielectric layer 11 when the first internal electrode layer 12a and the second internal electrode layer 12b are made of nickel, the dielectric layer 11 is made of barium titanate, and the intermediate layer 130 is made of a complex oxide of nickel and titanium. The vertical axis of FIG. 5 represents the energy of electrons with the vacuum energy level set to 0 eV.

As shown in FIG. 5, the work function of nickel, that is, the energy of the valence band maximum of the first internal electrode layer 12a and the second internal electrode layer 12b made of nickel is −4.9 eV, the energy of the valence band maximum of the intermediate layer 130 made of a complex oxide of nickel and titanium is lower than −4.9 eV, and the energy of the valence band maximum of the dielectric layer 11 made of barium titanate is even lower. Also, the energy of the conduction band minimum of the intermediate layer 130 is higher than the energy of the conduction band minimum of the dielectric layer 11. Therefore, the energy difference ΔEn1 between the valence band maximum of the first internal electrode layer 12a and the second internal electrode layer 12b and the conduction band minimum of the intermediate layer 130 is larger than the energy difference ΔEn0 between the valence band maximum of the first internal electrode layer 12a and the second internal electrode layer 12b and the conduction band minimum of the dielectric layer 11. In the first embodiment, the energy difference ΔEn1 is an energy barrier to electrons, and the energy difference ΔEp1 between the valence band maximum of the first internal electrode layer 12a and the second internal electrode layer 12b and the valence band maximum of the intermediate layer 130 is an energy barrier to holes. Therefore, compared with the case where the intermediate layer 130 is not provided, a high energy barrier exists between the dielectric layer 11 and the first internal electrode layer 12a and second internal electrode layer 12b. Therefore, according to the first embodiment, a high insulation property can be obtained between the first internal electrode layer 12a and the second internal electrode layer 12b, and high insulation reliability can be obtained in the multilayer ceramic capacitor 100.

As for the concentration of the element contained in the element body 10, when the concentration analyzed and quantified by energy dispersive X-ray spectroscopy (EDX) analysis with a transmission electron microscope (TEM) is used, it is difficult to separate the dielectric layer of the perovskite structure in which both element A and element B exist from the intermediate layer in which element A substantially does not exist and element B exists due to the problem of analytical accuracy. Therefore, the concentration quantified by three-dimensional atom probe (3DAP) analysis is used.

### [Manufacturing Method of Multilayer Ceramic Capacitor]

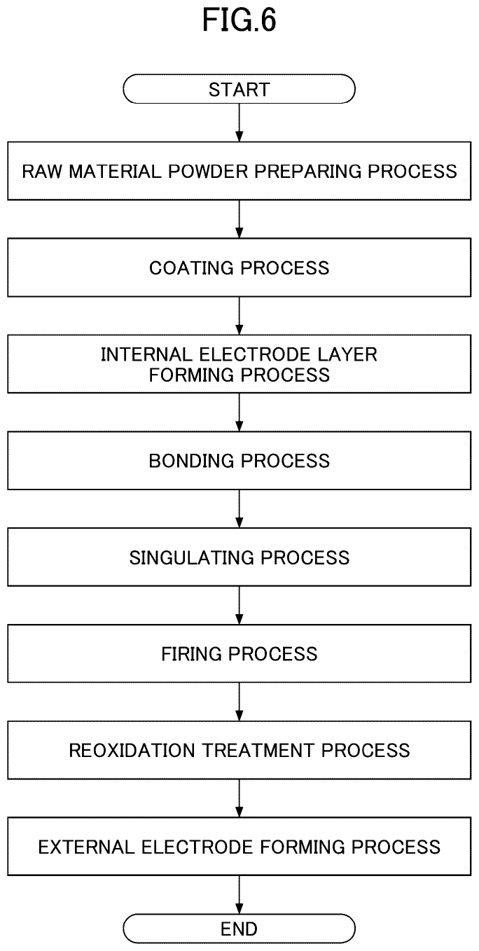

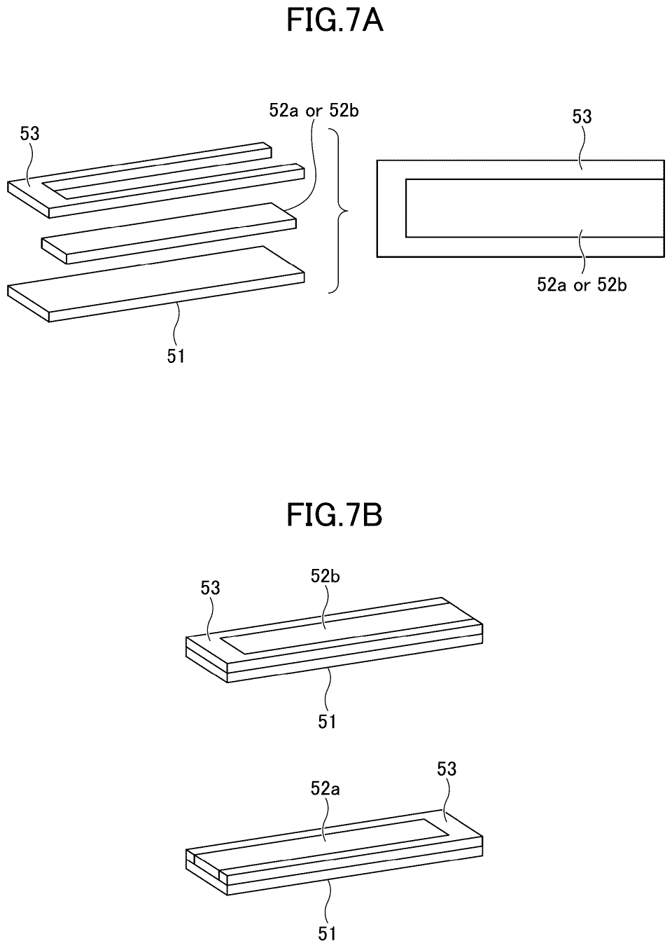

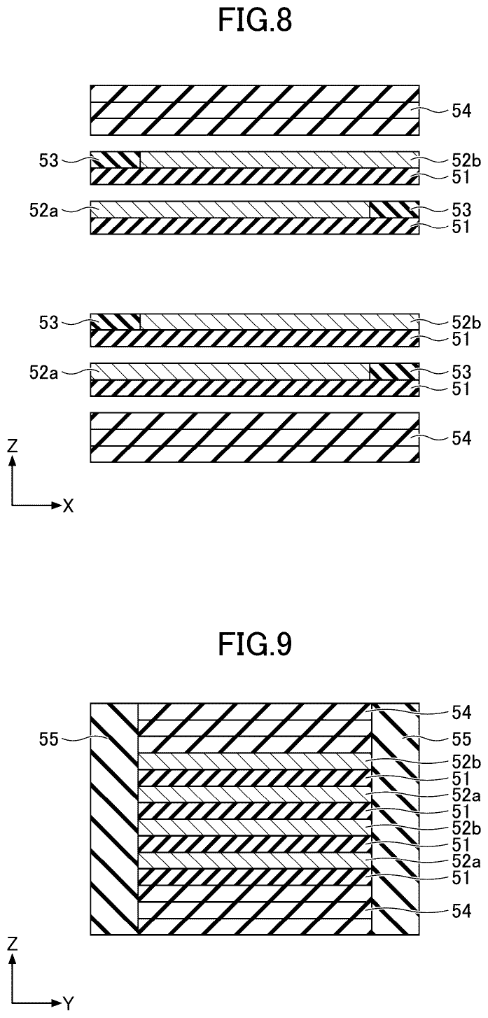

Next, a manufacturing method of the multilayer ceramic capacitor 100 will be described. FIG. 6 is a flowchart illustrating a manufacturing method of the multilayer ceramic capacitor 100. FIGS. 7A to 8 are drawings illustrating a manufacturing method of the multilayer ceramic capacitor 100.

### [Raw Material Powder Preparing Process]

First, a dielectric material for forming the dielectric layer 11 is prepared. The A-site element and the B-site element contained in the dielectric layer 11 are usually contained in the dielectric layer 11 in the form of sintered ABO₃ particles. For example, barium titanate is a tetragonal compound having a perovskite structure and has a high relative dielectric constant. The barium titanate can generally be obtained by synthesizing barium titanate by reacting a titanium raw material such as titanium dioxide with a barium raw material such as barium carbonate. Various methods have conventionally been known for synthesizing the main ceramic component of the dielectric layer 11, such as a solid phase method, a sol-gel method, a hydrothermal method, and the like. In the present embodiment, any of these methods can be adopted.

A predetermined additive compound is added to the obtained ceramic raw material powder according to the purpose. Additional compounds include oxides of zirconium (Zr), magnesium (Mg), manganese (Mn), molybdenum (Mo), vanadium (V), chromium (Cr), rare earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm) and ytterbium (Yb)), oxides containing cobalt (Co), nickel (Ni), lithium (Li), boron (B), sodium (Na), potassium (K) or silicon (Si), or glass containing cobalt, nickel, lithium, boron, sodium, potassium or silicon.

For example, a ceramic material is prepared by wet-mixing a ceramic raw material powder with a compound containing an additive compound, and then drying and pulverizing the mixture. For example, the ceramic material obtained as described above may be pulverized as necessary to adjust the particle size, or may be combined with a classification treatment to adjust the particle size. A dielectric material is obtained by the above processes.

### [Coating Process]

Next, a binder such as a polyvinyl butyral (PVB) resin, an organic solvent such as ethanol or toluene, and a plasticizer are added to the obtained raw material powder and wet-mixed. Using the obtained slurry, a ceramic green sheet 51 is coated on a substrate by a die coater method or a doctor blade method, for example, and dried. The substrate is, for example, a polyethylene terephthalate (PET) film. Illustrations illustrating the coating process are omitted. The ceramic green sheet 51 is an example of a dielectric green sheet.

### [Internal Electrode Layer Forming Process]

As described above, the first internal electrode layer 12a and the second internal electrode layer 12b are mainly composed of a base metal such as nickel (Ni), copper (Cu), tin (Sn), or an alloy containing these metals. A noble metal such as platinum (Pt), palladium (Pd), silver (Ag), gold (Au), or an alloy containing these metals may also be used. The main component of the first internal electrode layer 12a and the main component of the second internal electrode layer 12b may be the same or different. As an example, the main component of both the first internal electrode layer 12a and the second internal electrode layer 12b may be nickel.

A metal conductive paste for forming the precursor of the first internal electrode layer 12a and the second internal electrode layer 12b is prepared by kneading the main component selected from above, an organic binder, and a solvent.

Next, as shown in FIG. 7A, the first internal electrode layer pattern 52a for the first internal electrode layer 12a or the second internal electrode layer pattern 52b for the second internal electrode layer 12b is arranged on the surface of the ceramic green sheet 51 by printing a metal conductive paste containing an organic binder by screen printing, gravure printing, or the like. Ceramic particles can also be added to the metal conductive paste as a co-material. The main component of the ceramic particles is not particularly limited, but is preferably the same as the main component ceramic of the dielectric layer 11. When ceramic particles are added as a co-material, they can be added during the kneading of the metal conductive paste. The method of forming the internal electrode layer is not limited to printing; plating, vacuum deposition, sputtering, or CVD may also be used.

Next, an ethyl cellulosic-based binder or similar and a terpineol-based organic solvent or similar are added to the dielectric pattern material obtained in the raw material powder manufacturing process, and the mixture is kneaded in a roll mill to obtain a dielectric pattern paste for the reverse pattern layer. As shown in FIG. 7A, the dielectric pattern 53 is arranged on the ceramic green sheet 51 by printing the dielectric pattern paste in a peripheral region where the internal electrode layer pattern is not printed, and the unevenness with respect to the internal electrode layer pattern is filled. The ceramic green sheet 51 on which the internal electrode layer pattern and the dielectric pattern 53 are printed is referred to as a lamination unit.

Thereafter, as shown in FIG. 7B, the lamination units are laminated (or stacked) such that the internal electrode layers and the dielectric layers, with the edges of the internal electrode layers being alternately exposed on respective end surfaces in the longitudinal direction of the dielectric layers, are alternately connected to a pair of external electrodes with different polarities. Specifically, a ceramic green sheet 51 on which a first internal electrode layer pattern 52a and a dielectric pattern 53 are printed and a ceramic green sheet 51 on which a second internal electrode layer pattern 52b and a dielectric pattern 53 are printed are laminated in this order. For example, the number of the laminated lamination units is 100 to 500.

### [Bonding Process]

As shown in FIG. 8, a predetermined number (e.g., 2 to 10 layers) of cover sheets 54 are laminated on the upper and lower portions of the laminated body, which is formed by laminating the lamination units, and thermocompression bonding is performed.

### [Singulating Process]

A bonded body is singulated. Existing singulating methods such as dicing with a dicer or laser cutting can be used as appropriate.

### [Firing Process]

Thereafter, firing (or sintering) is performed in a reducing atmosphere having an oxygen partial pressure of not less than 10⁻⁹ atm and not more than 10⁻¹⁰ atm and a temperature range of not less than 1100° C. and not more than 1350° C., for not less than five minutes and not more than ten hours. As a result, the ceramic green sheet 51 is more strongly reduced than in a general firing process, and the concentration of reduced titanium is higher in the vicinity of the interface between the ceramic green sheet 51 and the first internal electrode layer pattern 52a or the second internal electrode layer pattern 52b, where oxygen is more easily desorbed, than in a general firing process. Preferably, the temperature range is not less than 1150° C. and not more than 1350° C.

### [Reoxidation Treatment Process]

In order to return oxygen to the partially reduced main phase of the fired ceramic green sheet 51, heat treatment is performed in a mixed gas of nitrogen (N₂) and water vapor at approximately 1000° C., or in air at not less than 500° C. and not more than 700° C., to such an extent that the first internal electrode layer pattern 52a and the second internal electrode layer pattern 52b are not completely oxidized. This process is referred to as a reoxidation treatment process. As a result, by mutual diffusion between the ceramic green sheet 51 and the first internal electrode layer pattern 52a and mutual diffusion between the ceramic green sheet 51 and the second internal electrode layer pattern 52b, an intermediate layer 130 including a layer containing titanium atoms reduced in the firing process, a main component of the first internal electrode layer pattern 52a or the second internal electrode layer pattern 52b, and oxygen atoms, and containing almost no barium atoms, is formed.

### [External Electrode Forming Process]

Thereafter, the first external electrode 20a and the second external electrode 20b are formed by plating or the like. By the above processes, the multilayer ceramic capacitor 100 is completed.

The above process is only an example, and it is not necessary to perform reverse pattern printing, for example. It is also possible to form a side margin part separately without performing reverse pattern printing. In this case, a dielectric pattern material for forming the side margin 16 is prepared in advance. The dielectric pattern material includes powder of the main component ceramic of the side margin 16. As the main component ceramic powder, for example, a main component ceramic powder of a dielectric material can be used. A predetermined additive compound may be added according to the purpose. The side margin part may be applied or coated on the lateral faces of a singulated laminated portion. Specifically, as shown in FIG. 9, the laminated portion is obtained by laminating and singulating the ceramic green sheets 51, and the first internal electrode layer pattern 52a and the second internal electrode layer pattern 52b having the same width as the ceramic green sheet 51. Next, a sheet formed of dielectric pattern paste may be applied as a side margin 55 on the lateral face of the laminated portion. FIG. 9 is a drawing illustrating an application of the side margin part.

It should be noted that in the manufacturing method described above, the intermediate layer is formed by firing under conditions different from those of the conventional method, but the intermediate layer may be formed as follows. That is, in the internal electrode layer forming process, a first intermediate layer pattern is formed on the ceramic green sheet 51, an internal electrode layer pattern is formed on the first intermediate layer pattern, and a second intermediate layer pattern is formed on the internal electrode layer pattern. The first intermediate layer pattern and the second intermediate layer pattern are patterns to be intermediate layers and have the same composition as the intermediate layer. The first intermediate layer pattern and the second intermediate layer pattern are preferably formed by a sputtering method. In this way, a laminate having the ceramic green sheet 51, the first intermediate layer pattern, the internal electrode layer pattern, and the second intermediate layer pattern is prepared. In the firing process, the laminate is fired in a reducing atmosphere. In this way, an intermediate layer can be formed.

### Variation of First Embodiment

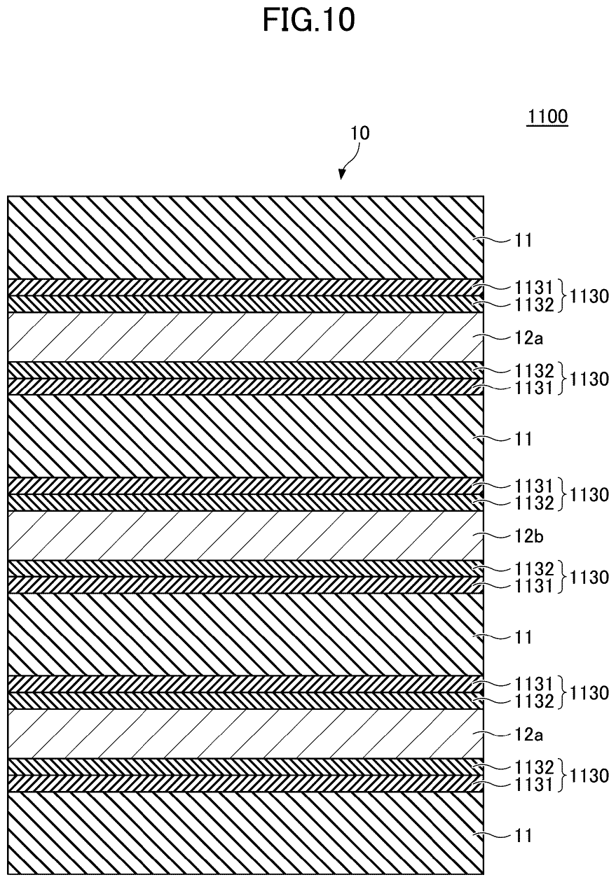

Next, a variation of the first embodiment will be described. The variation of the first embodiment differs from the first embodiment mainly with regard to the configuration of the intermediate layer. FIG. 10 is a cross-sectional view illustrating details of an element body 10 according to the variation of the first embodiment.

In the multilayer ceramic capacitor 1100 according to the variation of the first embodiment, the element body 10 has an intermediate layer 1130 instead of the intermediate layer 130. The intermediate layer 1130 has a first region 1131 and a second region 1132. In the intermediate layer 1130 located between the adjacent first internal electrode layer 12a and the dielectric layer 11, the second region 1132 is located between the first region 1131 and the first internal electrode layer 12a, and the first region 1131 is located between the second region 1132 and the dielectric layer 11. In the intermediate layer 1130 located between the adjacent second internal electrode layer 12b and the dielectric layer 11, the second region 1132 is located between the first region 1131 and the second internal electrode layer 12b, and the first region 1131 is located between the second region 1132 and the dielectric layer 11. Like the intermediate layer 130 in the first embodiment, the first region 1131 includes M atoms, B atoms, and oxygen atoms, and substantially does not include the element A. Furthermore, in the first region 1131, the total amount of oxygen atoms is greater than the total amount of B atoms, and the total amount of M atoms is greater than the total amount of B atoms. Characterizing the variation is the second region 1132, wherein the second region 1132 includes M atoms and oxygen atoms, and substantially does not include element A or B atoms. The proportion of element A and B atoms in the second region 1132 is 5 at % or less.

Other configurations of the variation of the first embodiment are the same as those of the first embodiment.

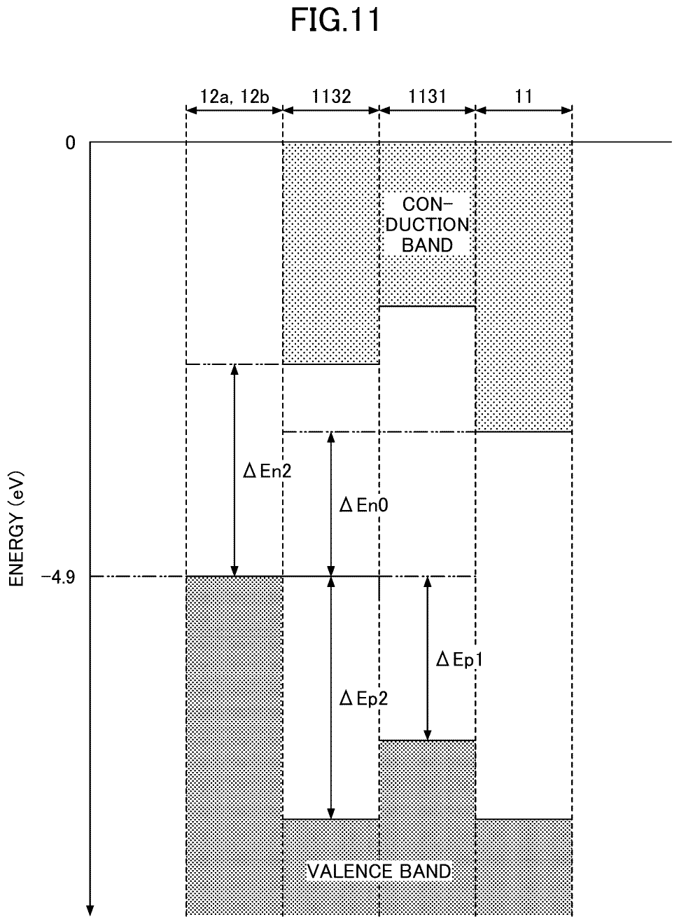

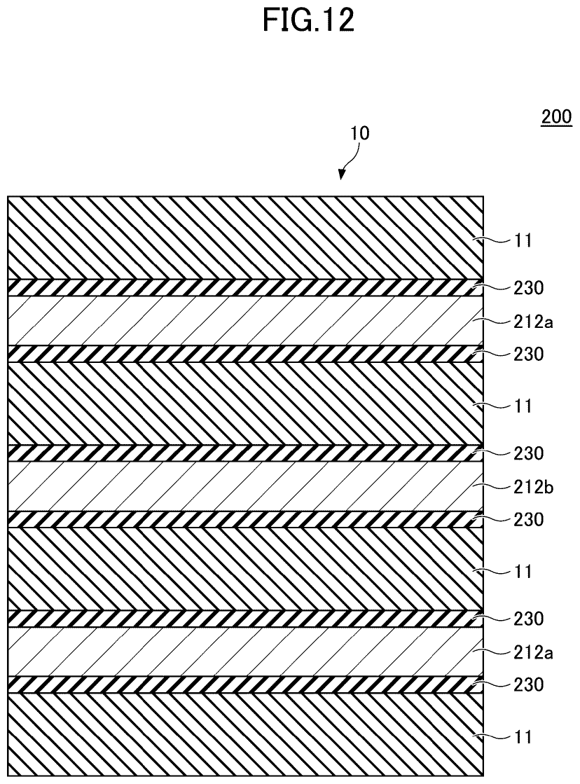

FIG. 11 shows a band alignment of the first internal electrode layer 12a, the second internal electrode layer 12b, the first region 1131, the second region 1132, and the dielectric layer 11, when the first internal electrode layer 12a and the second internal electrode layer 12b are made of nickel, the dielectric layer 11 is made of barium titanate, the first region 1131 is made of a complex oxide of nickel and titanium, and the second region 1132 is made of a nickel oxide. As in FIG. 5, the vertical axis of FIG. 11 indicates the energy of electrons with the vacuum energy level set to 0 eV.

As shown in FIG. 11, the energy difference ΔEn2 between the valence band maximum of the first internal electrode layer 12a and the second internal electrode layer 12b and the conduction band minimum of the second region 1132 is larger than the energy difference ΔEn0. Furthermore, the energy difference ΔEp2 between the valence band maximum of the first internal electrode layer 12a and the second internal electrode layer 12b and the valence band maximum of the second region 1132 is larger than the energy difference ΔEp1 between the valence band maximum of the first internal electrode layer 12a and the second internal electrode layer 12b and the valence band maximum of the first region 1131. Further, the band alignment of the first region 1131 is the same as that of the intermediate layer 130 in the first embodiment. In the variation of the first embodiment, the energy difference ΔEn2 is an energy barrier to electrons, and the energy difference ΔEp2 is an energy barrier to holes. Thus, the energy barrier to electrons (energy difference ΔEn2) is higher than the energy difference ΔEn0, and the energy barrier to holes (energy difference ΔEp2) is higher than the energy barrier to holes (energy difference ΔEp1) in the first embodiment. Therefore, a higher energy barrier exists between the first internal electrode layer 12a and second internal electrode layer 12b and the dielectric layer 11 than in the first embodiment. Therefore, according to the second embodiment, higher insulation can be obtained between the first internal electrode layer 12a and the second internal electrode layer 12b, and higher insulation reliability can be obtained by the multilayer ceramic capacitor 1100.

In manufacturing the multilayer ceramic capacitor 1100 according to the variation of the first embodiment, for example, the oxygen partial pressure in the firing process may be set to 10⁻⁸ atm or more and 10⁻⁹ atm or less, and the temperature range may be set to 1100° C. or more and 1350° C. or less. Preferably, the oxygen partial pressure may be set to 10⁻⁸ atm or more and less than 10⁻⁹ atm, and the temperature range may be set to 1150° C. or more and 1350° C. or less.

### Second Embodiment

Next, the second embodiment will be described. The second embodiment differs from the first embodiment mainly in the configuration of the internal electrode layer and the intermediate layer. FIG. 12 is a cross-sectional view illustrating the details of the element body 10 in the second embodiment.

In the multilayer ceramic capacitor 200 according to the second embodiment, the element body 10 has a first internal electrode layer 212a instead of a first internal electrode layer 12a, a second internal electrode layer 212b instead of a second internal electrode layer 12b, and an intermediate layer 230 instead of an intermediate layer 130.

The first internal electrode layer 212a and the second internal electrode layer 212b include a subcomponent M1 in addition to the same main component as the first internal electrode layer 12a and the second internal electrode layer 12b. The first internal electrode layer 212a and the second internal electrode layer 212b contain, as the subcomponent M1, at least one selected from the group consisting of, for example, tin (Sn), iron (Fe), chromium (Cr), cobalt (Co), manganese (Mn), aluminum (Al), hafnium (Hf), zirconium (Zr), scandium (Sc), yttrium (Y), niobium (Nb), molybdenum (Mo), ruthenium (Ru), tungsten (W), tantalum (Ta), rhenium (Re), bismuth (Bi), holmium (Ho), dysprosium (Dy), gadolinium (Gd), silicon (Si), germanium (Ge), and indium (In). The oxidation number of these elements (first element) can be a value higher than the valence of nickel. The first internal electrode layer 212a and the second internal electrode layer 212b may contain, as the subcomponent M1, at least one selected from the group consisting of vanadium (V), osmium (Os), zinc (Zn), titanium (Ti), and lanthanoid elements.

The intermediate layer 230 includes M1 atoms, which are subcomponents of the first internal electrode layer 212a or the second internal electrode layer 212b, M atoms, B atoms, and oxygen atoms, and substantially contains no A atoms. The proportion of M atoms, B atoms, and oxygen atoms in the intermediate layer 230 is 50 at % or more in total, and the proportion of A atoms is 5 at % or less. The total amount of oxygen atoms is greater than the total amount of B atoms, and the total amount of M atoms is greater than the total amount of B atoms. For example, the M atom is nickel, the A atom is barium, the B atom is titanium, and the M1 atom, which is a subcomponent of the first internal electrode layer 212a and the second internal electrode layer 212b, is tin.

Other configurations of the second embodiment are same as those of the first embodiment.

The second embodiment can also provide the same effects as the first embodiment. Also, in the second embodiment, the first internal electrode layer 212a and the second internal electrode layer 212b include M1 atoms of an appropriate subcomponent. Therefore, surplus electrons generated by subcomponent substitution of the main component raise the Fermi level, and the conduction band minimum of the intermediate layer 230 becomes higher and the valence band maximum of the intermediate layer 230 becomes higher than in the first embodiment without the subcomponent. That is, the ionization potential and electron affinity of the intermediate layer 230 in the second embodiment with the subcomponent are lower than the ionization potential and electron affinity of the intermediate layer 130 in the first embodiment without the subcomponent. Therefore, a higher energy barrier exists between the first internal electrode layer 212a and second internal electrode layer 212b and the dielectric layer 11 than in the first embodiment. Therefore, according to the second embodiment, higher insulation can be obtained between the first internal electrode layer 212a and the second internal electrode layer 212b, and higher insulation reliability can be obtained by the multilayer ceramic capacitor 200.

In manufacturing the multilayer ceramic capacitor 200 according to the second embodiment, for example, a subcomponent may be included in addition to the main component in a metal conductive paste for forming the internal electrode layer, and a firing process may be performed under the same conditions as in the first embodiment.

### Variation of Second Embodiment

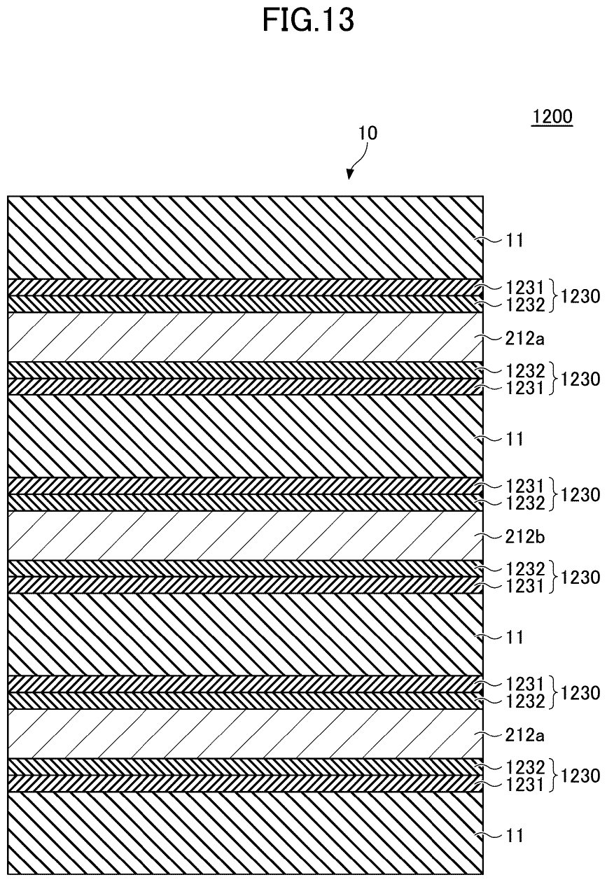

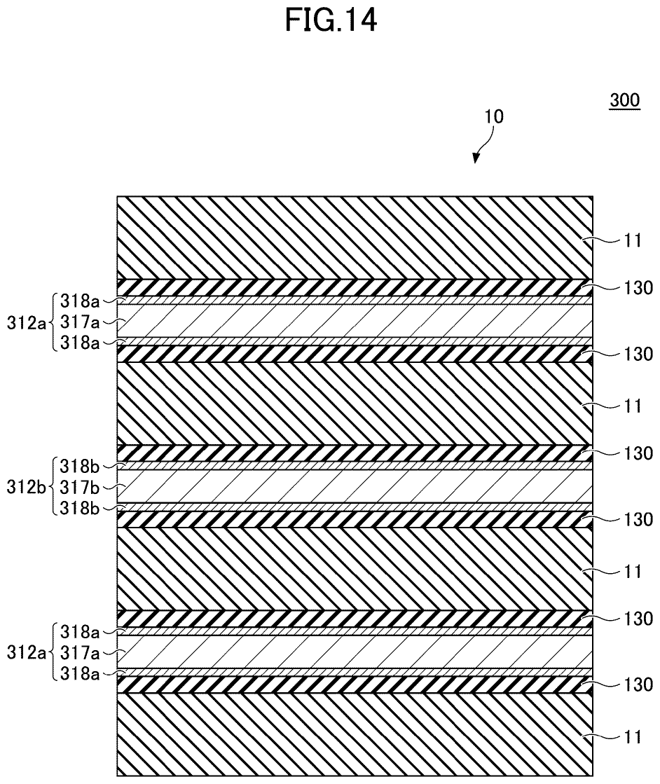

Next, a variation of the second embodiment will be described. The variation of the second embodiment differs from the second embodiment mainly in the configuration of the intermediate layer. FIG. 13 is a cross-sectional view illustrating details of the element body 10 in the variation of the second embodiment.

In the multilayer ceramic capacitor 1200 according to the variation of the second embodiment, the element body 10 has an intermediate layer 1230 instead of the intermediate layer 230. The intermediate layer 1230 has a first region 1231 and a second region 1232. In the intermediate layer 1230 positioned between the adjacent first internal electrode layer 212a and the dielectric layer 11, the second region 1232 is positioned between the first region 1231 and the first internal electrode layer 212a, and the first region 1231 is positioned between the second region 1232 and the dielectric layer 11. In the intermediate layer 1230 located between the adjacent second internal electrode layer 212b and the dielectric layer 11, the second region 1232 is located between the first region 1231 and the second internal electrode layer 212b, and the first region 1231 is located between the second region 1232 and the dielectric layer 11. Like the intermediate layer 230 in the second embodiment, the first region 1231 includes M1 atoms, M atoms, B atoms, and oxygen atoms, and substantially does not include the element A. Further, in the first region 1231, the total amount of oxygen atoms is greater than the total amount of B atoms, and the total amount of M atoms is greater than the total amount of B atoms. The second region 1232 includes M atoms and oxygen atoms, and substantially does not include element A or B atoms. The proportion of element A and B atoms in the second region 1232 is 5 at % or less.

Other configurations of the variation of the second embodiment are the same as those of the second embodiment.

The same effects as those of the second embodiment can also be obtained by the variation of the second embodiment. Further, since the intermediate layer 1230 has the first region 1231 and the second region 1232, higher insulation reliability can be obtained, as in the variation of the first embodiment.

In manufacturing the multilayer ceramic capacitor 1200 according to the variation of the second embodiment, for example, as in the second embodiment, a subcomponent may be included in addition to the main component in the metal conductive paste for forming the internal electrode layer, and the firing process may be performed under the same conditions as in the variation of the first embodiment.

### Third Embodiment

Next, the third embodiment will be described. The third embodiment differs from the first embodiment mainly in the configuration of the internal electrode layer. FIG. 14 is a cross-sectional view illustrating the details of the element body 10 in the third embodiment.

In the multilayer ceramic capacitor 300 according to the third embodiment, the element body 10 has a first internal electrode layer 312a instead of a first internal electrode layer 12a, and a second internal electrode layer 312b instead of a second internal electrode layer 12b.

The first internal electrode layer 312a and the second internal electrode layer 312b include a segregation component M2 in addition to the same main component M as the first internal electrode layer 12a and the second internal electrode layer 12b. The first internal electrode layer 312a has a base 317a and two segregation parts 318a. The segregation part 318a is located between the base 317a and the intermediate layer 130. The second internal electrode layer 312b has a base 317b and two segregation parts 318b. The segregation part 318b is located between the base 317b and the intermediate layer 130. The thickness of the segregation parts 318a and 318b is extremely thin, for example, 5 nm to 8 nm. The first internal electrode layer 312a and the second internal electrode layer 312b contain at least one additive element (second element) selected from the group consisting of gold (Au), copper (Cu), platinum (Pt), rhodium (Rh), iridium (Ir), palladium (Pd), silver (Ag), and germanium (Ge) as a segregation component M2 in addition to the same main component M as the first internal electrode layer 12a and the second internal electrode layer 12b. In the first internal electrode layer 312a, the additive element is segregated in the segregation part 318a, and in the second internal electrode layer 312b, the additive element is segregated in the segregation part 318b. That is, the peak of the concentration of the additive element is within a range of 5 nm from the interface between the first internal electrode layer 312a and the intermediate layer 130 of the second internal electrode layer 312b. Since the segregation parts 318a and 318b are portions on the surface side of the first internal electrode layer 312a and the second internal electrode layer 312b, respectively, they contain almost no oxygen. The segregation parts 318a and 318b and the intermediate layer 130 can be distinguished according to the amount of oxygen. The portion where the concentration of oxygen is 5 at % or less is defined as the segregation parts 318a and 318b. Although the segregation component M2 is also included in the base 317a of the first internal electrode layer 312a and the base 317b of the second internal electrode layer 312b, the proportion of the segregation component M2 in the segregation parts 318a and 318b is 1.5 times or more of the proportion of the segregation component M2 in the base 317a and 317b. Also, the proportion of the segregation component M2 in the intermediate layer 130 is ⅓ or less of the maximum value of the proportion of the segregation component M2 in the segregation parts 318a and 318b.

Other configurations of the third embodiment are same as those of the first embodiment.

According to the third embodiment, the same effects as those of the first embodiment can be obtained. Also, in the third embodiment, the first internal electrode layer 312a has the segregation part 318a, and the second internal electrode layer 312b has the segregation part 318b. Therefore, the work functions of the first internal electrode layer 312a and the second internal electrode layer 312b are higher than those of the first internal electrode layer 12a and the second internal electrode layer 12b, and the energy difference between the valence band maximum of the first internal electrode layer 312a and the second internal electrode layer 312b and the conduction band minimum of the intermediate layer 130 is larger than the energy difference between the valence band maximum of the first internal electrode layer 12a and the second internal electrode layer 12b and the conduction band minimum of the intermediate layer 130 in the first embodiment. Therefore, according to the third embodiment, higher insulation can be obtained between the first internal electrode layer 312a and the second internal electrode layer 312b, and higher insulation reliability can be obtained by the multilayer ceramic capacitor 300.

In manufacturing the multilayer ceramic capacitor 300 according to the third embodiment, for example, an additive element may be added to a metal conductive paste for forming the internal electrode layer in addition to the main component, and a firing process may be performed under the same conditions as in the first embodiment.

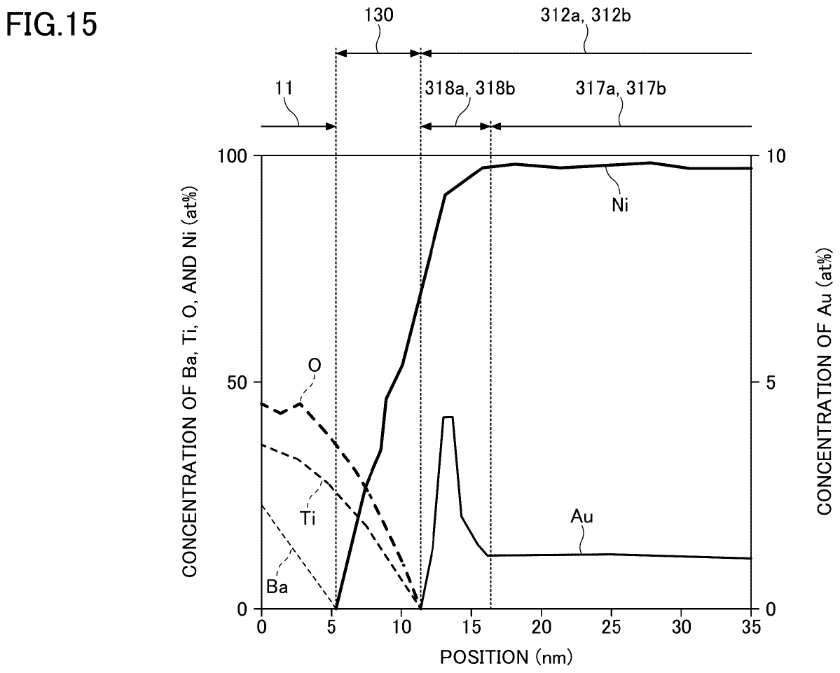

As an example, FIG. 15 shows concentration distributions of barium, titanium, oxygen, nickel and gold when the first internal electrode layer 312a and the second internal electrode layer 312b are made of nickel-gold alloy, the dielectric layer 11 is made of barium titanate, and the intermediate layer 130 contains a nickel-titanium complex oxide. In the example shown in FIG. 15, the first internal electrode layer 312a and the second internal electrode layer 312b contain nickel and gold, and gold concentration peaks exist in the segregation parts 318a and 318b. Also, the intermediate layer 130 contains nickel and titanium, but contains almost no gold. The dielectric layer 11 contains barium, but the intermediate layer 130 contains almost no barium. It should be note that the horizontal axis in FIG. 15 indicates a distance based on a position approximately 5 nm away from the interface between the dielectric layer 11 and the intermediate layer 130. Also, the components contained in the ceramic green sheet at the time of manufacturing are indicated by dashed lines, and the components contained in the metal conductive paste for forming the internal electrode layer are indicated by solid lines.

### Variation of Third Embodiment

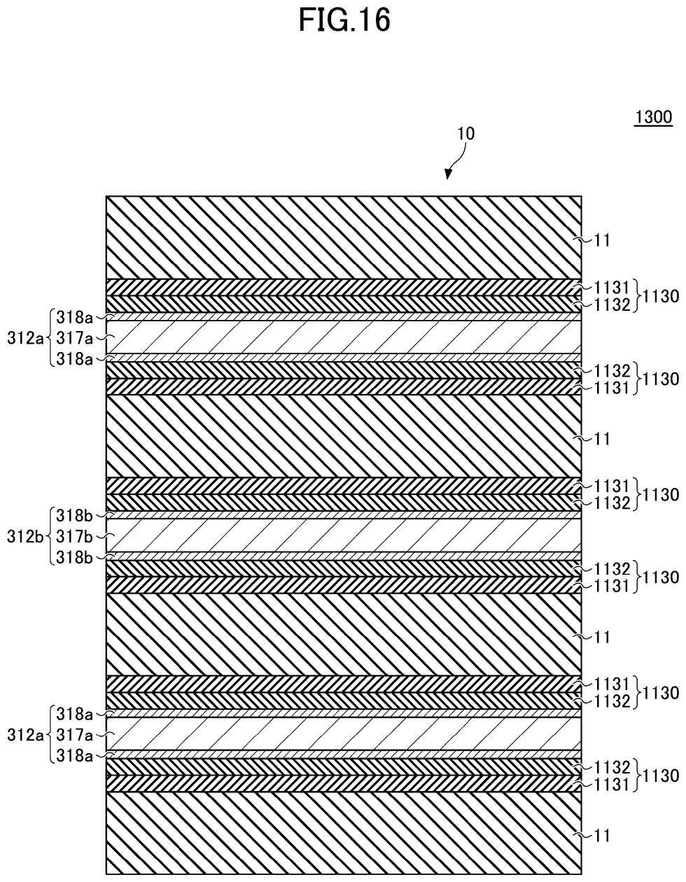

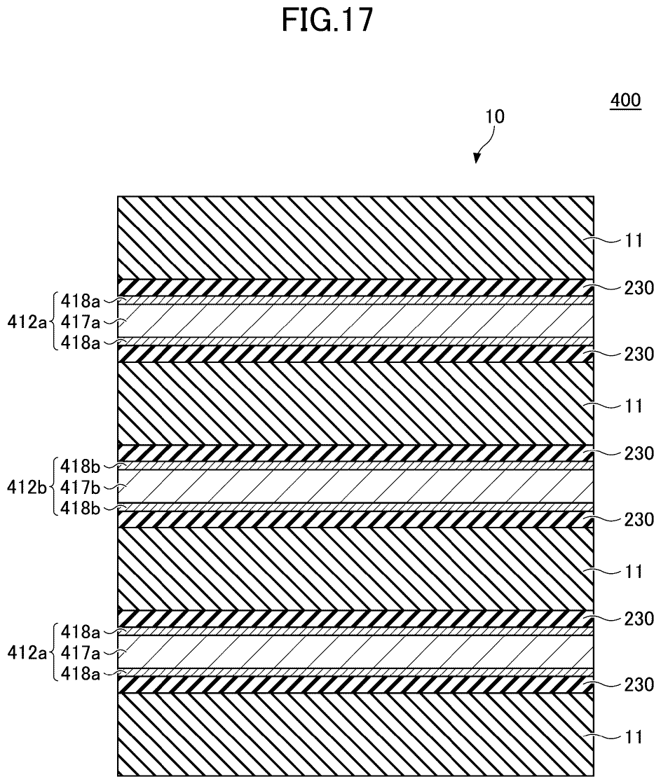

Next, a variation of the third embodiment will be described. The variation of the third embodiment differs from the third embodiment mainly in the configuration of the intermediate layer. FIG. 16 is a cross-sectional view illustrating details of the element body 10 according to the variation of the third embodiment.

In the multilayer ceramic capacitor 1300 according to the variation of the third embodiment, the element body 10 has an intermediate layer 1130 instead of the intermediate layer 130. The intermediate layer 1130 has the same configuration as in the variation of the first embodiment.

Other configurations of the variation of the third embodiment are the same as those of the third embodiment.

The same effect as in the third embodiment can also be obtained by the variation of the third embodiment. Further, since the intermediate layer 1130 has the first region 1131 and the second region 1132, higher insulation reliability can be obtained, as in the variation of the first embodiment.

In manufacturing the multilayer ceramic capacitor 1300 according to the variation of the third embodiment, for example, as in the third embodiment, a metal conductive paste for forming the internal electrode layer may be made to contain a segregation component in addition to the main component, and a firing process may be performed under the same conditions as in the variation of the first embodiment.

### Fourth Embodiment

Next, the fourth embodiment will be described. The fourth embodiment differs from the second embodiment mainly in the configuration of the internal electrode layer. FIG. 17 is a cross-sectional view illustrating details of the element body 10 according to the fourth embodiment.

In the multilayer ceramic capacitor 400 according to the fourth embodiment, the element body 10 has a first internal electrode layer 412a instead of the first internal electrode layer 212a, and a second internal electrode layer 412b instead of the second internal electrode layer 212b.

The first internal electrode layer 412a and the second internal electrode layer 412b include a segregation component M2 in addition to a main component M and a subcomponent M1 similar to those of the first internal electrode layer 212a and the second internal electrode layer 212b. The first internal electrode layer 412a has a base 417a and two segregation parts 418a. The segregation part 418a is located between the base 417a and the intermediate layer 230. The second internal electrode layer 412b has a base 417b and two segregation parts 418b. The segregation part 418b is located between the base 417b and the intermediate layer 230. The thickness of the segregation parts 418a and 418b is extremely thin, for example, 5 nm to 8 nm. The first internal electrode layer 412a and the second internal electrode layer 412b contain at least one additive element selected from the group consisting of gold (Au), copper (Cu), platinum (Pt), rhodium (Rh), iridium (Ir), palladium (Pd), silver (Ag), and germanium (Ge) as the segregation component M2 in addition to the main component M and the subcomponent M1 similar to those of the first internal electrode layer 212a and the second internal electrode layer 212b. In the first internal electrode layer 412a, the additive element segregates in the segregation part 418a, and in the second internal electrode layer 412b, the additive element segregates in the segregation part 418b. That is, the peak of the concentration of the additive element is within a range of 5 nm from the interface between the first internal electrode layer 412a and the intermediate layer 230 of the second internal electrode layer 412b. Since the segregation parts 418a and 418b are portions on the surface side of the first internal electrode layer 412a and the second internal electrode layer 412b, respectively, they contain almost no oxygen. The segregation parts 418a and 418b and the intermediate layer 230 can be distinguished by the amount of oxygen. The portion where the concentration of oxygen is 5 at % or less is defined as the segregation part 418a or 418b. Although the segregation component M2 is also included in the base 417a of the first internal electrode layer 412a and the base 417b of the second internal electrode layer 412b, the proportion of the segregation component M2 in the segregation parts 418a and 418b is 1.5 times or more of the proportion of the segregation component M2 in the base 417a and 417b. Also, the proportion of the segregation component M2 in the intermediate layer 230 is ⅓ or less of the maximum value of the proportion of the segregation component M2 in the segregation parts 418a and 418b.

Other configurations of the fourth embodiment are same as those of the second embodiment.

According to the fourth embodiment, the same effects as those of the second embodiment can be obtained. In the fourth embodiment, the first internal electrode layer 412a has the segregation part 418a, and the second internal electrode layer 412b has the segregation part 418b. Therefore, the work functions of the first internal electrode layer 412a and the second internal electrode layer 412b are higher than those of the first internal electrode layer 212a and the second internal electrode layer 212b, and the energy difference between the valence band maximum of the first internal electrode layer 412a and the second internal electrode layer 412b and the conduction band minimum of the intermediate layer 230 is larger than the energy difference between the valence band maximum of the first internal electrode layer 212a and the second internal electrode layer 212b and the conduction band minimum of the intermediate layer 230 in the second embodiment. Therefore, according to the fourth embodiment, higher insulation can be obtained between the first internal electrode layer 412a and the second internal electrode layer 412b, and higher insulation reliability can be obtained by the multilayer ceramic capacitor 400.

In manufacturing the multilayer ceramic capacitor 400 according to the fourth embodiment, for example, an additive element may be added to the metal conductive paste for forming the internal electrode layer in addition to the main component and the subcomponent, and the firing process may be performed under the same conditions as in the first embodiment.

### Variation of Fourth Embodiment

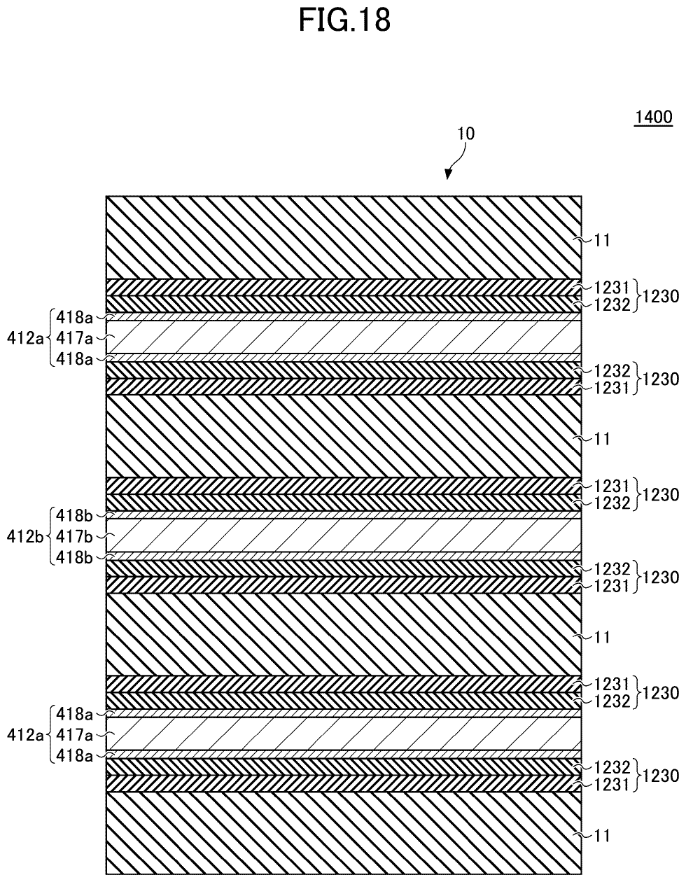

Next, a variation of the fourth embodiment will be described. The variation of the fourth embodiment differs from the fourth embodiment mainly in the configuration of the intermediate layer. FIG. 18 is a cross-sectional view illustrating details of the element body 10 according to the variation of the fourth embodiment.

In the multilayer ceramic capacitor 1400 according to the variation of the fourth embodiment, the element body 10 has an intermediate layer 1230 in place of the intermediate layer 230. The intermediate layer 1230 has the same configuration as in the variation of the second embodiment.

Other configurations of the variation of the fourth embodiment are the same as those of the fourth embodiment.

The same effects as those of the fourth embodiment can also be obtained by the variation of the fourth embodiment. Further, since the intermediate layer 1230 has the first region 1231 and the second region 1232, higher insulation reliability can be obtained, as in the variation of the second embodiment.

In manufacturing the multilayer ceramic capacitor 1400 according to the variation of the fourth embodiment, for example, as in the third embodiment, the metal conductive paste for forming the internal electrode layer may contain a segregation component in addition to the main component and the subcomponent, and the firing process may be performed under the same conditions as in the variation of the first embodiment.

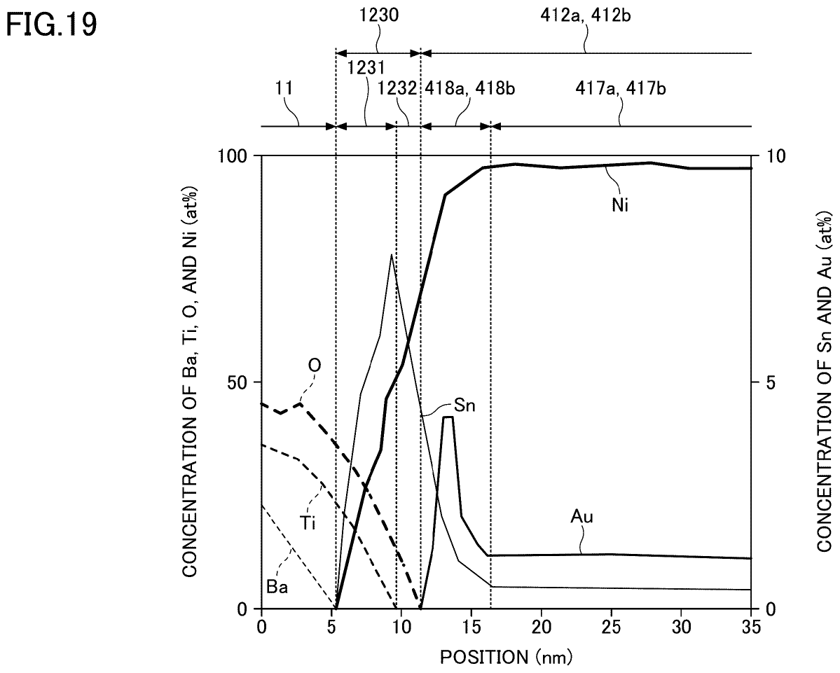

As an example, when the first internal electrode layer 412a and the second internal electrode layer 412b are made of a nickel-tin-gold alloy, the dielectric layer 11 is made of barium titanate, the first region 1231 is made of a complex oxide of nickel, titanium, and tin, and the second region 1232 is made of a complex oxide of nickel and tin, the concentration distributions of barium, titanium, oxygen, nickel, tin, and gold are illustrated in FIG. 19. In the example shown in FIG. 19, the first internal electrode layer 412a and the second internal electrode layer 412b contain nickel, tin, and gold, and the concentration peaks of gold exist in the segregation parts 418a and 418b. The intermediate layer 1230 contains nickel and tin, but almost no gold. The intermediate layer 1230 has a first region 1231 containing titanium and a second region 1232 containing almost no titanium. The dielectric layer 11 contains barium, but the intermediate layer 1230 contains almost no barium. The horizontal axis in FIG. 19 indicates a distance based on a position approximately 5 nm away from the interface between the dielectric layer 11 and the intermediate layer 1230. The components contained in the ceramic green sheet at the time of manufacturing are indicated by dashed lines, and the components contained in the metal conductive paste for forming the internal electrode layer are indicated by solid lines.

It should be noted that in each embodiment, the thickness of the intermediate layer is preferably from 0.5 nm to 10 nm. If the thickness of the intermediate layer is less than 0.5 nm, it may be difficult to obtain the effect of improving the insulation by the intermediate layer. Conversely, if the thickness of the intermediate layer exceeds 10 nm, the capacitance between the electrodes tends to be low. The thickness of the intermediate layer is more preferably from 0.5 nm to 5 nm, and even more preferably from 0.5 nm to 3 nm.

### Other Embodiments

Further, the present disclosure is not limited to these embodiments, and various variations and alterations may be made without departing from the scope of the present disclosure.

For example, the above embodiments are applied to a multilayer ceramic capacitor having two terminal electrodes, but may also be applied to a multilayer ceramic capacitor having three or more terminals. In particular, the dielectric layer described in the above embodiments is also suitable for a three-terminal capacitor, which is generally used for high frequencies with a low equivalent series inductance (ESL), because the equivalent series resistance (ESR) is also required to be sufficiently low in the three-terminal capacitor.

Also, in the above embodiments, a multilayer ceramic capacitor has been described as an example of a multilayer ceramic electronic component, but the present disclosure is applicable to all multilayer ceramic electronic components. Examples of such multilayer ceramic electronic components include, for example, a chip varistor, a chip thermistor, and a multilayer inductor.

### EXAMPLES AND COMPARATIVE EXAMPLES

For the multilayer ceramic capacitor of each of the Comparative Example and the Examples of the first embodiment, a variation of the first embodiment, the second embodiment, the third embodiment, and a variation of the fourth embodiment, 50 test samples were prepared, and a DC voltage of 18 V at 125° C. was applied to each test sample. The time until half of the test samples failed was referred to as 50% lifespan.

Comparative Example 1 is a multilayer ceramic capacitor in which an internal electrode layer made of nickel and a dielectric layer made of barium titanate are in contact with each other without an intermediate layer.

Example 2 is a multilayer ceramic capacitor modeled after the first embodiment, wherein the internal electrode layer is made of nickel, the intermediate layer is made of a complex oxide of nickel and titanium, and the dielectric layer is made of barium titanate.

Example 3 is a multilayer ceramic capacitor modeled after a variation of the first embodiment, wherein the internal electrode layer is made of nickel, the intermediate layer is composed of a first region composed of a complex oxide of nickel and titanium, and a second region composed of an oxide of nickel, and the dielectric layer is made of barium titanate.

Example 4 is a multilayer ceramic capacitor modeled after the second embodiment, wherein the internal electrode layer is made of a nickel-tin alloy, the intermediate layer is made of a complex oxide of nickel, titanium, and tin, and the dielectric layer is made of barium titanate.

Example 5 is a multilayer ceramic capacitor modeled after the third embodiment, wherein the internal electrode layer is made of a nickel-gold alloy, the intermediate layer is made of a complex oxide of nickel and titanium, and the dielectric layer is made of barium titanate.

Example 6 is a multilayer ceramic capacitor modeled after a variation of the fourth embodiment, wherein the internal electrode layer is made of a nickel-tin-gold alloy, the intermediate layer is composed of a first region made of a complex oxide of nickel, titanium, and tin, and a second region made of a complex oxide of nickel and tin, and the dielectric layer is made of barium titanate.

Table 1 shows a summary of the configuration and 50% lifespan of Comparative Example 1 and Examples 2 to 6.

TABLE 1

| | Component | | Component of | | |
|---|---|---|---|---|---|
| | of Internal | Segre- | Intermediate Layer | | 50% |
| | Electrode | gated | First | Second | Lifespan |
| | Layer | Element | Region | Region | (Minutes) |
| Comparative | Ni | No | No | | 4860 |
| Example 1 | | | | | |
| Example 2 | Ni | No | Ni, Ti, O | | 5800 |
| Example 3 | Ni | No | Ni, Ti, O | Ni, O | 7100 |
| Example 4 | Ni, Sn | No | Ni, Ti, Sn, O | | 12900 |
| Example 5 | Ni, Au | Au | Ni, Ti, O | | 13400 |
| Example 6 | Ni, Sn, Au | Au | Ni, Ti, | Ni, Sn, O | 21150 |
| | | | Sn, O | | |

As shown in Table 1, Example 2 provided a 50% lifespan superior to that of Comparative Example 1, Example 3 provided a 50% lifespan superior to that of Example 2, and Example 4 provided a 50% lifespan superior to that of Example 3. Example 5 provided a 50% lifespan superior to that of Example 4, and Example 6 provided a 50% lifespan superior to that of Example 5. The features disclosed herein yield more than predictable results, including those disclosed above, which are surprising to the skilled artisan.

Embodiments of the present disclosure are, for example, as follows.

<1>

A multilayer ceramic electronic component including:
a plurality of internal electrode layers laminated along a first axis;
a plurality of dielectric layers having a perovskite structure represented by a general formula ABO₃, and positioned between adjacent internal electrode layers of the plurality of internal electrode layers; and
an intermediate layer positioned between an internal electrode layer of the plurality of internal electrode layers and a dielectric layer of the plurality of dielectric layers which are adjacent each other,
wherein when a main component element of the internal electrode layer is referred to as M, an element at an A-site of the dielectric layer is referred to as A, and an element at a B-site is referred to as B,
the intermediate layer includes M atoms, B atoms, and oxygen atoms, and
wherein a combined proportion of M atoms, B atoms, and oxygen atoms in the intermediate layer is 50 at % or more, and a proportion of A atoms is 5 at % or less.
   <2>

The multilayer ceramic electronic component according to <1>, wherein the internal electrode layer and the intermediate layer include at least one first element selected from a group consisting of tin, iron, chromium, cobalt, manganese, aluminum, hafnium, zirconium, scandium, yttrium, niobium, molybdenum, ruthenium, tungsten, tantalum, rhenium, bismuth, holmium, dysprosium, gadolinium, silicon, germanium, and indium,
wherein a proportion of the first element in the intermediate layer is 5 at % or less.
   <3>

The multilayer ceramic electronic component according to <1>, wherein the internal electrode layer includes at least one second element selected from a group consisting of gold, copper, platinum, rhodium, iridium, palladium, silver, and germanium,
wherein the internal electrode layer includes:
a base; and
a segregation part positioned between the base and the intermediate layer,
wherein a proportion of the second element in the segregation part is 1.5 times or more of a proportion of the second element in the base, and
wherein a proportion of the second element in the intermediate layer is ⅓ or less of a maximum value of the proportion of the second element in the segregation part.
   <4>

The multilayer ceramic electronic component according to <2>, wherein the internal electrode layer includes at least one second element selected from a group consisting of gold, copper, platinum, rhodium, iridium, palladium, silver, and germanium,
wherein the internal electrode layer includes:
a base; and
a segregation part positioned between the base and the intermediate layer,
wherein a proportion of the second element in the segregation part is 1.5 times or more of a proportion of the second element in the base, and
wherein a proportion of the second element in the intermediate layer is ⅓ or less of a maximum value of the proportion of the second element in the segregation part.
   <5>

The multilayer ceramic electronic component according to any one of <1> to <4>, wherein the intermediate layer includes:
a first region; and
a second region positioned between the first region and the internal electrode layer,
wherein the first region includes M atoms, B atoms, and oxygen atoms,
wherein in the first region, a total amount of oxygen atoms is greater than a total amount of B atoms, and a total amount of M atoms is greater than the total amount of B atoms,
wherein the second region includes M atoms and oxygen atoms, and
wherein a proportion of B atoms in the second region is 5 at % or less.
   <6>

The multilayer ceramic electronic component according to any one of <1> to <5>, wherein the main component element of the internal electrode layer is nickel, the element at the A-site of the dielectric layer is barium, and the element at the B-site is titanium.

<7>

The multilayer ceramic electronic component according to <3> or <4>, wherein a peak concentration of the additive element is within a range of 5 nm from an interface of the internal electrode layer with the intermediate layer.

<8>

The multilayer ceramic electronic component according to any one of <1> to <7>, wherein the intermediate layer has a thickness of not less than 0.5 nm and not more than 10 nm.

<9>

A manufacturing method of a multilayer ceramic electronic component including:
preparing a laminate including a dielectric green sheet having a perovskite structure represented by a general formula ABO₃, a first intermediate layer pattern on the dielectric green sheet, an internal electrode layer pattern on the first intermediate layer pattern, and a second intermediate layer pattern on the internal electrode layer pattern; and
firing the laminate in a reducing atmosphere,
wherein when a main component element of the internal electrode layer pattern is referred to as M, an element at an A-site of the dielectric green sheet is referred to as A, and an element at a B-site is referred to as B,
the first intermediate layer pattern and the second intermediate layer pattern include M atoms, B atoms, and oxygen atoms, and
wherein a combined proportion of M atoms, B atoms, and oxygen atoms in the first intermediate layer pattern and the second intermediate layer pattern is 50 at % or more, and a proportion of A atoms is 5 at % or less.
   <10>

The manufacturing method of the multilayer ceramic electronic component according to <9>, wherein firing the laminate in the reducing atmosphere is firing the laminate in an atmosphere having an oxygen partial pressure of 10⁻⁸ atm or more and 10⁻¹⁰ atm or less and a temperature range of 1100° C. or more and 1350° C. or less.

<11>

The manufacturing method of the multilayer ceramic electronic component according to <9>, wherein firing the laminate in the reducing atmosphere is firing the laminate in an atmosphere having an oxygen partial pressure of 10⁻⁹ atm or more and 10⁻¹⁰ atm or less and a temperature range of 1100° C. or more and 1300° C. or less.

<12>

The manufacturing method of the multilayer ceramic electronic component according to <9>, wherein firing the laminate in the reducing atmosphere is firing the laminate in an atmosphere having an oxygen partial pressure of 10⁻⁸ atm or more and 10⁻⁹ atm or less and a temperature range of 1150° C. or more and 1350° C. or less.

<13>

The manufacturing method of the multilayer ceramic electronic component according to any one of <9> to <12>, wherein a process for preparing the laminate includes:
forming the first intermediate layer pattern on the dielectric green sheet by sputtering; and
forming the second intermediate layer pattern on the internal electrode layer pattern by sputtering.

In this disclosure, in some embodiments, the material/composition including perovskite powders may consist of required/explicitly indicated elements described in the present disclosure; however, “consisting of” does not exclude additional components that are known equivalents to the elements and/or unrelated components such as impurities ordinarily associated with the elements. Also, in some embodiments, the term “main component” refers to “primary, majority, or predominant component in terms of quantity or quality, and the term “mainly composed of” refers to “primarily, mostly, or predominantly composed of” in terms of quantity or quality. Further, in some embodiments which are silent as to known components used in this technology field, the known components can explicitly be excluded from the embodiments. Also, in some embodiments, any two numbers of a variable can constitute a workable range of the variable as the workable range can be determined based on routine work, and any ranges indicated may include or exclude the endpoints. Additionally, any values of variables indicated (regardless of whether or not they are indicated with “about”) may refer to precise values or approximate/rounded values and include equivalents, and may refer to average, median, representative, majority, etc. in some embodiments. In this disclosure, “a” may refer to a species or a genus including multiple species, while a plural may not exclude singular according to the context. Further, “the invention” or “the present invention” may refer collectively to at least one of the embodiments or examples explicitly or inherently disclosed herein. Also, in some embodiments, any one or more of the disclosed elements or components as options can be exclusively selected or can expressly be excluded, depending on the target piezoelectric ceramic to be manufactured, its target properties, etc., and/or for practical reasons, operational reasons, etc. Additionally, in the present disclosure where conditions and/or structures are not specified, a skilled artisan in the art can readily provide such conditions and/or structures, in view of the present disclosure, as a matter of routine experimentation, etc.

The present application is based on and claims priority to Japanese patent application No. 2023-218263 filed on Dec. 25, 2023, with the Japanese Patent Office, the entire contents of which are hereby incorporated by reference.

What is claimed:

1. A multilayer ceramic electronic component comprising:
a plurality of internal electrode layers laminated along a first axis; and
a plurality of dielectric layers having a perovskite structure represented by a general formula ABO₃ and laminated along the first axis, wherein each internal electrode layer is positioned between adjacent dielectric layers of the plurality of dielectric layers;
wherein an intermediate layer is provided between an internal electrode layer of the plurality of internal electrode layers and a dielectric layer of the plurality of dielectric layers, which are adjacent to each other along the first axis, and
wherein when a main component element of the internal electrode layer is referred to as M, an element at an A-site of the dielectric layer is referred to as A, and an element at a B-site is referred to as B, the intermediate layer includes M atoms, B atoms, and oxygen atoms, and
in the intermediate layer, a combined proportion of M atoms, B atoms, and oxygen atoms is 50 at % or more, and a proportion of A atoms is 5 at % or less.

2. The multilayer ceramic electronic component according to claim 1, wherein the internal electrode layer and the intermediate layer include at least one first element selected from a group consisting of tin, iron, chromium, cobalt, manganese, aluminum, hafnium, zirconium, scandium, yttrium, niobium, molybdenum, ruthenium, tungsten, tantalum, rhenium, bismuth, holmium, dysprosium, gadolinium, silicon, germanium, and indium, wherein a proportion of the first element in the intermediate layer is 5 at % or less.

3. The multilayer ceramic electronic component according to claim 1, wherein the internal electrode layer includes at least one second element selected from a group consisting of gold, copper, platinum, rhodium, iridium, palladium, silver, and germanium,
wherein the internal electrode layer includes:
a base; and
a segregation part positioned between the base and the intermediate layer along the first axis,
wherein a proportion of the second element in the segregation part as a whole is 1.5 times or more of a proportion of the second element in the base as a whole, and
wherein a proportion of the second element throughout the intermediate layer is ⅓ or less of a maximum value of the proportion of the second element in the segregation part as viewed along the first axis.

4. The multilayer ceramic electronic component according to claim 2, wherein the internal electrode layer includes at least one second element selected from a group consisting of gold, copper, platinum, rhodium, iridium, palladium, silver, and germanium,
wherein the internal electrode layer comprises:
a base; and
a segregation part positioned between the base and the intermediate layer along the first axis,
wherein a proportion of the second element in the segregation part as a whole is 1.5 times or more of a proportion of the second element in the base as a whole, and
wherein a proportion of the second element throughout the intermediate layer is ⅓ or less of a maximum value of the proportion of the second element in the segregation part as viewed along the first axis.

5. The multilayer ceramic electronic component according to claim 1, wherein the intermediate layer comprises:
a first region; and
a second region positioned between the first region and the internal electrode layer along the first axis,
wherein the first region includes M atoms, B atoms, and oxygen atoms,
wherein in the first region, a total amount of oxygen atoms is greater than a total amount of B atoms, and a total amount of M atoms is greater than the total amount of B atoms,
wherein the second region includes M atoms and oxygen atoms, and
wherein a proportion of B atoms in the second region is 5 at % or less.

6. The multilayer ceramic electronic component according to claim 1, wherein the main component element of the internal electrode layer is nickel, the element at the A-site of the dielectric layer is barium, and the element at the B-site is titanium.

7. The multilayer ceramic electronic component according to claim 3, wherein a peak concentration of the second element is present in the internal electrode layer within a range of 5 nm from an interface of the internal electrode layer and the intermediate layer.

8. The multilayer ceramic electronic component according to claim 1, wherein the intermediate layer has a thickness of not less than 0.5 nm and not more than 10 nm.

9. A manufacturing method of a multilayer ceramic electronic component comprising:
preparing a laminate including a dielectric green sheet having a perovskite structure represented by a general formula ABO₃, a first intermediate layer pattern on the dielectric green sheet, an internal electrode layer pattern on the first intermediate layer pattern, and a second intermediate layer pattern on the internal electrode layer pattern; and
firing the laminate in a reducing atmosphere,
wherein when a main component element of the internal electrode layer pattern is referred to as M, an element at an A-site of the dielectric green sheet is referred to as A, and an element at a B-site is referred to as B, the first intermediate layer pattern and the second intermediate layer pattern include M atoms, B atoms, and oxygen atoms, and
in the first intermediate layer pattern and the second intermediate layer pattern, a combined proportion of M atoms, B atoms, and oxygen atoms is 50 at % or more, and a proportion of A atoms is 5 at % or less, after the laminate is fired.

10. The manufacturing method of the multilayer ceramic electronic component according to claim 9, wherein firing the laminate in the reducing atmosphere is firing the laminate in an atmosphere having an oxygen partial pressure of 10⁻⁸ atm or more and 10⁻¹⁰ atm or less and a temperature range of 1100° C. or more and 1350° C. or less.

11. The manufacturing method of the multilayer ceramic electronic component according to claim 9, wherein firing the laminate in the reducing atmosphere is firing the laminate in an atmosphere having an oxygen partial pressure of 10⁻⁹ atm or more and 10⁻¹⁰ atm or less and a temperature range of 1100° C. or more and 1300° C. or less.

12. The manufacturing method of the multilayer ceramic electronic component according to claim 9, wherein the firing laminate in the reducing atmosphere is firing the laminate in an atmosphere having an oxygen partial pressure of 10⁻⁸ atm or more and 10⁻⁹ atm or less and a temperature range of 1150° C. or more and 1350° C. or less.

13. The manufacturing method of the multilayer ceramic electronic component according to claim 9, wherein in preparing the laminate,
the first intermediate layer pattern is formed on the dielectric green sheet by sputtering; and
the second intermediate layer pattern is formed on the internal electrode layer pattern by sputtering.
